(19) United States
(12) Patent Application Publication
(10) Pub. No.: US 2024/0065805 A1
(43) Pub. Date: Feb. 29, 2024

(54) TOOTH EXTRACTION AUXILIARY TOOL AND TOOTH EXTRACTION TOOL SET

(71) Applicant: Kazuyoshi SUZUKI, CHIBA (JP)

(72) Inventor: Kazuyoshi SUZUKI, CHIBA (JP)

(21) Appl. No.: 18/020,806

(22) PCT Filed: Feb. 4, 2022
(86) PCT No.: PCT/JP2022/004522

§ 371 Date: Aug. 10, 2023

(51) Int. Cl. A61C 3/14

(52) U.S. Cl. CPC A61C 3/14

(57) ABSTRACT

Provided are a tooth extraction auxiliary tool and the like which can reduce a burden on a tooth serving as a tooth extraction target, an alveolar bone at this tooth extraction target site, and/or adjacent teeth. A tooth extraction auxiliary tool 1 having a first auxiliary substrate 11 and a second auxiliary substrate 12 is used. The first auxiliary substrate 11 is inserted into a recessed portion X0 formed in a tooth X2, and a hot melt adhesive M is injected. In a state where the tooth extraction auxiliary tool 1 is firmly fixed to the tooth X2 by the solidified hot melt adhesive M, the second auxiliary substrate 12 is gripped by fingertips of an operator, and the tooth X2 is pulled out from a gum X1 while the tooth X2 is twisted.

### TECHNICAL FIELD

The present invention relates to a tooth extraction auxiliary tool.

### BACKGROUND ART

When a tooth is extracted in dental treatment, in general, the tooth is pinched, extracted, and removed by dental forceps (pliers) after the tooth is dislocated by inserting a lever (Hebei) into a site of a periodontal ligament around a tooth root between the tooth and an alveolar bone (for example, refer to Patent Literatures 1 and 2).

However, in a case where the tooth is accidentally pushed when the tooth is twisted with the lever, the case may cause the following problems. Nerves may be hurt, blood vessels may be damaged, excessive bleeding may occur, or the alveolar bone may collapse.

Therefore, the present inventor has proposed a tooth extraction auxiliary tool that enables safer and easier tooth extraction (for example, refer to Patent Literature 3). This tooth extraction auxiliary tool includes a screw portion screwed into the tooth, a handle portion, and a non-slip portion formed on the handle portion. Once the handle portion is grasped and the screw portion is screwed into a hole in a central portion of the tooth, and the screw portion is firmly wedged into the tooth, force is applied to the handle portion and the tooth is pulled out from the gums. When a twisting force acts on the tooth root, the tooth relatively easily floats from the alveolar bone. Accordingly, the tooth can be easily extracted. Therefore, a force for extracting the tooth is applied only to the tooth on which tooth extraction is performed without using the lever in extracting the tooth. Accordingly, the tooth extraction is safe since the tooth extraction is less likely to be affected by adjacent teeth or is less likely to affect the adjacent teeth (for example, refer to Patent Literature 4).

### CITATION LIST

### Patent Literatures

Patent Literature 1: Japanese Patent Application Laid-Open No. 2002-291753 (FIG. 1)
Patent Literature 2: Japanese Patent Application Laid-Open No. 2009-119095 (FIG. 15)
Patent Literature 3: Japanese Registered Utility Model No. 3162169
Patent Literature 4: Japanese Registered Utility model No. 3162226

### SUMMARY OF INVENTION

### Technical Problem

However, the screw portion needs to be firmly wedged into the tooth. Therefore, it is unavoidable that a force acting in a twisting direction at this time is applied to the tooth. Even in this case, when the screw portion is screwed into the hole in the central portion of the tooth with the handle portion and is fixed to the tooth by being firmly wedged into the tooth, it is preferable that the force acting in the twisting direction is not applied to the tooth so much.

Therefore, an object of the present invention is to provide a tooth extraction auxiliary tool which can reduce a burden on a tooth to be extracted, an alveolar bone at this tooth extraction site, and/or adjacent teeth.

### Solution to Problem

According to the present invention, there is provided a tooth extraction auxiliary tool including a first auxiliary substrate inserted into a recessed portion formed in a tooth, a second auxiliary substrate, a connection portion that connects the first auxiliary substrate and the second auxiliary substrate, and an interval adjustment mechanism for adjusting an interval between the first auxiliary substrate and the second auxiliary substrate via the connection portion.

In the tooth extraction auxiliary tool having the above-described configuration, it is preferable that the interval adjustment mechanism is configured to include a male screw portion formed in the connection portion and a female screw portion formed in the second auxiliary substrate and screwed to the male screw portion.

According to the present invention, there is provided a tooth extraction tool set including the tooth extraction auxiliary tool according to the present invention, and a tooth extraction tool having an engagement portion guided to a gap between the second auxiliary substrate and the tooth and engaging with the second auxiliary substrate, in a state where the first auxiliary substrate is inserted into the recessed portion formed in the tooth.

In the tooth extraction tool set having the above-described configuration, it is preferable that the tooth extraction tool includes a first substrate extending in a longitudinal direction and a second substrate connected to one end portion of the first substrate in the longitudinal direction and inserted into an oral cavity of a patient, and at least one of an engagement cutout portion that divides a tip portion of the second substrate, and an engagement hole in the second substrate, the engagement hole being configured to include a first hole through which the second auxiliary substrate is allowed to pass in the second substrate and a second hole through which the second auxiliary substrate is not allowed to pass and continuous with the first hole, is formed in the second substrate, as the engagement portion.

In the tooth extraction tool set having the above-described configuration, it is preferable that the second substrate of the tooth extraction tool is formed in a convex curved surface shape, and a bottom portion of the second substrate is formed in a flat shape, or is formed in a convex curved surface shape having a smaller curvature than a periphery of the bottom portion.

According to the tooth extraction auxiliary tool and the tooth extraction tool set of the present invention, the recessed portion (cavity portion or recess) into which the first auxiliary substrate can be inserted to a certain degree is formed in the tooth. In a state where the first auxiliary substrate is inserted into the recessed portion, a hot melt adhesive injected into the recessed portion is solidified so that the tooth extraction auxiliary tool is fixed to the tooth. Thereafter, a force is applied to the second auxiliary substrate so that the tooth is easily pulled out from the gums. In this manner, a burden on the tooth serving as a tooth extraction target and teeth adjacent to the tooth extraction target can be reduced.

### BRIEF DESCRIPTION OF DRAWINGS

FIG. 1 is a view illustrating a configuration of a tooth extraction auxiliary tool as a first embodiment of the present invention.

FIG. 2 is a view illustrating a using method of the tooth extraction auxiliary tool as the first embodiment of the present invention.

FIG. 3 is a view illustrating a configuration of a tooth extraction auxiliary tool as a second embodiment of the present invention.

FIG. 4 is view illustrating a configuration of a tooth extraction tool as an embodiment of the present invention.

FIG. 5 is view illustrating a using mode of a tooth extraction tool set as an embodiment of the present invention.

FIG. 6 is a view illustrating a configuration of a tooth extraction auxiliary tool as a third embodiment of the present invention.

### DESCRIPTION OF EMBODIMENTS

### First Embodiment

(Configuration)

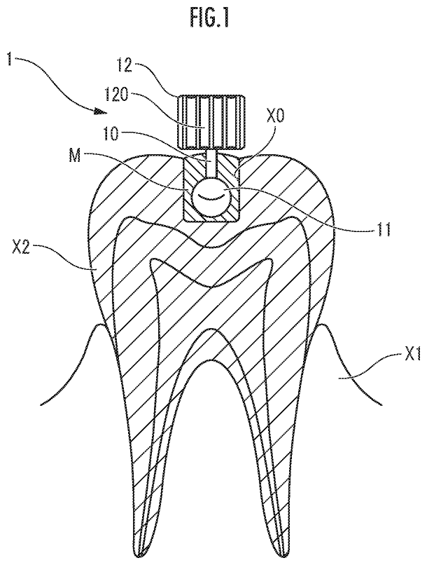

A tooth extraction auxiliary tool 1 as a first embodiment of the present invention illustrated in FIG. 1 includes a first auxiliary substrate 11, a second auxiliary substrate 12, and a connection portion 10 that connects the first auxiliary substrate 11 and the second auxiliary substrate 12. A material of the tooth extraction auxiliary tool 1 is selected in any desired way. For example, the tooth extraction auxiliary tool 1 is formed of a nickel-titanium alloy.

The first auxiliary substrate 11 is formed in a substantially spherical shape. As illustrated in FIG. 1, a size of the first auxiliary substrate 11 is designed to be a size which can be inserted into a recessed portion X0 formed in a crown of a tooth X2 in a state where a tooth root is embedded in a gum X1. A shape of the first auxiliary substrate 11 may be not only the substantially spherical shape, but also a substantially elliptical spherical shape, a substantially hemispherical shape, a substantially cubic shape, a substantially rectangular shape, a substantially cylindrical shape, a substantially square columnar shape, a substantially conical shape, a substantially square conical shape, a substantially conical trapezoidal shape, or a substantially square conical trapezoidal shape. Alternatively, various shapes such as a combination of the above-described shapes may be used. The same applies to other embodiments.

The second auxiliary substrate 12 is formed in a substantially cylindrical shape or substantially disk shape having a larger diameter than that of the first auxiliary substrate 11. A shape of the second auxiliary substrate 12 may be not only a substantially cylindrical shape or a substantially disk shape, but also a substantially regular polygonal plate shape, a substantially spherical shape, a substantially elliptical sphere shape, a substantially hemispherical shape, a substantially cubic shape, a substantially rectangular shape, a substantially cylindrical shape, a substantially square columnar shape, a substantially conical shape, a substantially square conical shape, a substantially conical trapezoidal shape, or a substantially square conical trapezoidal shape. Alternatively, various shapes such as a combination of the above-described shapes may be used. The same applies to other embodiments.

On a side surface of the second auxiliary substrate 12, a plurality of protruding stripe portions 120 protruding outward in a radial direction in a linear shape extending in an axial direction is formed to be disposed apart from each other in a circumferential direction. Instead of the plurality of protruding stripe portions 120, on the side surface of the second auxiliary substrate 12, a plurality of groove portions or recessed stripe portions recessed inward in the radial direction in a linear shape extending in the axial direction may be formed to be disposed apart from each other in the circumferential direction. Instead of the plurality of protruding stripe portions 120, on the side surface of the second auxiliary substrate 12, various uneven structures may be formed so that a plurality of substantially hemispherical protruding portions protruding outward in the radial direction is dispersed and disposed.

The connection portion 10 is formed in a substantially cylindrical shape or a rod shape having a smaller diameter than that of the first auxiliary substrate 11. The connection portion 10 is integrally or detachably fixed to the first auxiliary substrate 11 in one end portion for the first auxiliary substrate 11 so that a central axis of the connection portion 10 coincides with or substantially coincides with a central axis of the first auxiliary substrate 11. The connection portion 10 is integrally or detachably fixed to the second auxiliary substrate 12 in the other end portion so that the central axis of the connection portion 10 coincides with or substantially coincides with the central axis of the second auxiliary substrate 12.

In addition to the substantially cylindrical shape, a shape of the connection portion 10 may adopt various shapes such as a curved shape and a spiral shape. The connection portion 10 may be fixed to the first auxiliary substrate 11 in one end portion so that the central axis of the connection portion 10 is inclined with respect to the central axis of the first auxiliary substrate 11. The connection portion 10 may be fixed to the second auxiliary substrate 12 in the other end portion so that the central axis of the connection portion 10 is inclined with respect to the central axis of the second auxiliary substrate 12. The same applies to other embodiments.

(Using Method)

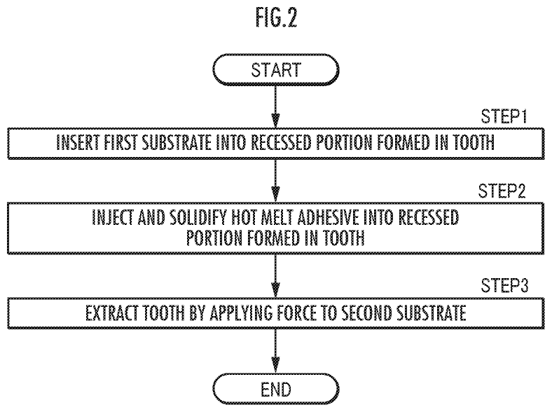

A using method of the tooth extraction auxiliary tool 1 having the above-described configuration will be described. First, as illustrated in FIG. 1, the recessed portion X0 having such a size that the first auxiliary substrate 11 can be inserted is formed by a cutting tool in the crown of the tooth X2, and the first auxiliary substrate 11 is inserted into the recessed portion X0 (FIG. 2/STEP 1). Next, a hot melt adhesive M melted by using a hot melt injection tool is injected into the recessed portion X0 in a state where the first auxiliary substrate 11 is inserted, and the hot melt adhesive M is solidified. In this manner, as illustrated in FIG. 1, the tooth extraction auxiliary tool 1 is fixed to the tooth X2 with the solidified hot melt adhesive M (FIG. 2/STEP 2).

In view of a treatment time limitation, it is preferable that the hot melt adhesive M is one that solidified as quickly as possible. In general, an amorphous poly alpha olefin (APAO) resin or an ethylene vinyl acetate (EVA) resin are applicable. In order to quicken the solidification of the hot melt adhesive M, a treatment method may be used so that the hot melt adhesive M is cooled by forcibly blowing air or pouring water. Other adhesives are contained in a tube in a viscous liquid form. Consequently, a cap needs to be removed or tightened, thereby causing troubles. Compared to other adhesives, the hot melt adhesive M can be used as it is at any time as long as the hot melt adhesive M is set in the hot melt injection tool. In this regard, the hot melt adhesive M is suitable for a tooth extraction treatment. When the hot melt injection tool imitates a pistol, it is easy to aim at the target tooth X2.

Then, after the second auxiliary substrate 12 is gripped by fingertips of an operator, the second auxiliary substrate 12 is moved in a direction away from the gum X1 while a twisting force is applied to the second auxiliary substrate 12. In this manner, the tooth X2 is pulled out from the gum X1 (FIG. 2/STEP 3).

The protruding stripe portions 120 are formed on the side surface of the second auxiliary substrate 12. Therefore, when the second auxiliary substrate 12 is gripped by a thumb and an index finger and/or a middle finger and a rotational force or a twisting force are applied around the central axis of the second auxiliary substrate 12, slippage between the fingers and the second auxiliary substrate 12 due to saliva or other factors is suppressed. When the tooth X2 floats from the gum X1 due to the twisting force applied to the tooth X2, the second auxiliary substrate 12 is strongly gripped by the fingers, or pinched between jaw portions of a forceps and the tooth X2 is pulled out from the gum X1 (the tooth is extracted).

### Second Embodiment

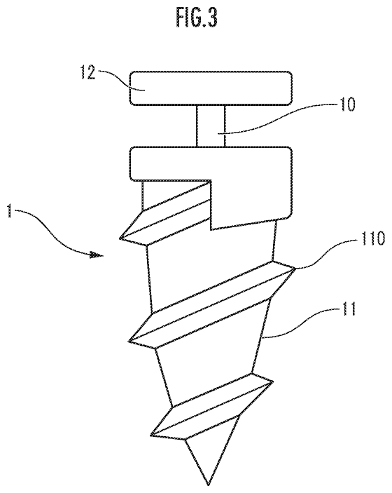

(Configuration) The tooth extraction auxiliary tool 1 as a second embodiment of the present invention illustrated in FIG. 3 includes the first auxiliary substrate 11, the second auxiliary substrate 12, and the connection portion 10 that connects the first auxiliary substrate 11 and the second auxiliary substrate 12.

The first auxiliary substrate 11 is formed in a substantially triangular pyramid shape having a size which can be inserted into the recessed portion X0 drilled in the crown of the tooth X2 in a state where the tooth root is embedded in the gum X1. A male screw portion 110 spirally extending along a side surface of a convex curved surface shape of the first auxiliary substrate 11 is formed. The male screw portion 110 may be omitted. Instead of the male screw portion 110, an uneven structure such as one or more protrusions protruding outward from a side surface of the first auxiliary substrate 11, and/or a recessed portion may be formed on the side surface of the first auxiliary substrate 11.

The second auxiliary substrate 12 is formed in a substantially cylindrical shape or a substantially disk shape having a diameter substantially the same as that of a bottom portion of the first auxiliary substrate 11. As in the first embodiment, the protruding stripe portion, the recessed stripe portion, and/or the protruding portion for preventing slippage may be formed on the side surface of the second auxiliary substrate 12.

The connection portion 10 is formed in a substantially cylindrical shape or a rod shape having a smaller diameter than that of the first auxiliary substrate 11. The connection portion 10 is integrally or detachably fixed to the first auxiliary substrate 11 in one end portion for the first auxiliary substrate 11 so that a central axis of the connection portion 10 coincides with or substantially coincides with a central axis of the first auxiliary substrate 11. The connection portion 10 is integrally or detachably fixed to the second auxiliary substrate 12 in the other end portion so that the central axis of the connection portion 10 coincides with or substantially coincides with the central axis of the second auxiliary substrate 12.

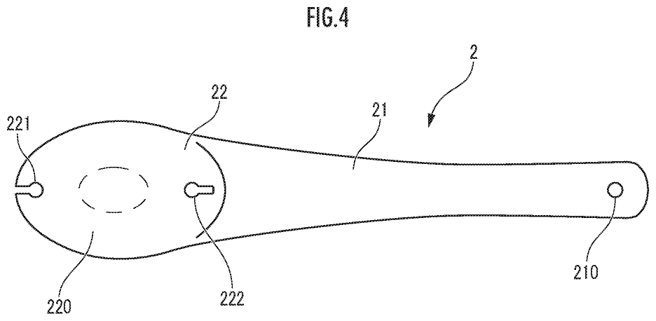

FIG. 4 illustrates a tooth extraction tool 2 forming a tooth extraction tool set together with the tooth extraction auxiliary tool 1 illustrated in FIG. 3. As illustrated in FIG. 4, the tooth extraction tool 2 has a first substrate 21 having an elongated flat plate shape in a top view, and a second substrate 22 provided in one end portion of the first substrate 21 in the longitudinal direction and having a substantially oval shape or a substantially elliptical shape in a top view.

A hole 210 for string passage is formed in the other end portion of the first substrate 21. The second substrate 22 is formed in a convex curved surface shape like a spoon as a whole but is formed to be flat or substantially flat in a bottom portion 220 (meaning that curvature in the second substrate 22 is smaller than that in a peripheral portion thereof). An engagement cutout portion 221 is formed in a tip portion of the second substrate 22 to divide the tip portion into two forks. A rear end portion of the second substrate 22 has an engagement hole 222 configured to include a substantially circular hole having a diameter larger than the diameter of the second auxiliary substrate 12 of the tooth extraction auxiliary tool 1 and a substantially rectangular hole having a width smaller than the diameter of the second auxiliary substrate 12 continuous behind the substantially circular hole. The engagement cutout portion 221 reaches an edge portion of the second substrate 22, but the engagement hole 222 does not reach an edge portion of the second substrate 22 (portion continuous with the first substrate 21).

Instead of the engagement cutout portion 221, an engagement hole similar to the engagement hole 222 may be formed in the tip portion of the second substrate 22.

(Using Method)

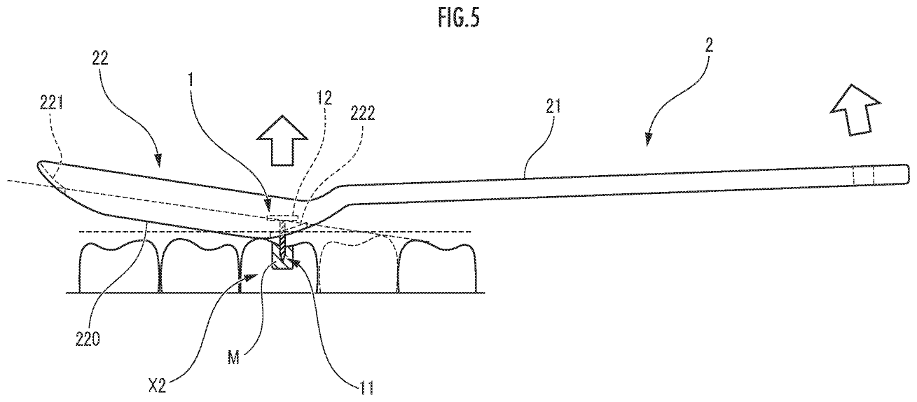

A using method of the tooth extraction auxiliary tool 1 having the above-described configuration and the tooth extraction tool set configured to include the tooth extraction auxiliary tool 1 and the tooth extraction tool 2 will be described. First, the recessed portion X0 having such a size such that the first auxiliary substrate 11 can be inserted is formed by a cutting tool in the crown of the tooth X2 (refer to FIG. 1), and as illustrated in FIG. 5, the first auxiliary substrate 11 is inserted into the recessed portion X0 (refer to FIG. 2/STEP 1).

Next, the hot melt adhesive M melted by using a hot melt injection tool is injected into the recessed portion X0 in a state where the first auxiliary substrate 11 is inserted, and the hot melt adhesive M is solidified. In this manner, as illustrated in FIG. 5, the tooth extraction auxiliary tool 1 is fixed to the tooth X2 with the solidified hot melt adhesive M (refer to FIG. 2/STEP 2).

Then, while an operator holding the first substrate 21 of the tooth extraction tool 2 searches for an upper surface portion of a dentition adjacent to the tooth X2 (in a direction in which the second substrate 22 is inserted into an oral cavity) with the bottom portion 220, the engagement hole 222 of the second substrate 22 is hooked on the second auxiliary substrate 12 of the tooth extraction auxiliary tool 1. Thereafter, the tooth extraction tool 2 is moved in a direction away from the gum X1 so that the tooth X2 is pulled out from the gum X1 together with the tooth extraction auxiliary tool 1 (refer to FIG. 2/STEP 3).

The flat or substantially flat bottom portion 220 of the substantially spoon-shaped second substrate 22 enables the operator to search for not only the upper surface portion of the dentition but also the corners of the dentition. It is possible to search for a corner portion of the tooth and a stepped portion of the dentition. Accordingly, the operator can adapt himself or herself to individual circumstances such as a status in which a mouth of a patient is less likely to open and/or a shape of the mouth, a posture of the operator, and tooth alignment and/or engagement of the patient.

While the operator holding the first substrate 21 of the tooth extraction tool 2 searches for the upper surface portion of the dentition adjacent to the tooth X2 (in a direction opposite to the direction in which the second substrate 22 is inserted into the oral cavity) with the bottom portion 220 of the second substrate 22, the engagement cutout portion 221 in the tip portion of the second substrate 22 may be hooked on the second auxiliary substrate 12 of the tooth extraction auxiliary tool 1. Then, the first substrate 21 of the tooth extraction tool 2 may be pushed, and the tooth X2 may be pulled out from the gum X1 together with the tooth extraction auxiliary tool 1.

In this way, the tooth adjacent to the teeth X2 is less affected, and the tooth can be safely, stably, and easily extracted. Therefore, a burden on the patient and a burden on the operator in carrying out tooth extraction work are reduced. The shape of the second substrate 22 is a substantially oval shape in a top view. Therefore, the patient feels less resistance when the second substrate 22 is inserted into the oral cavity of the patient. In this sense, the patient feels relieved.

In the tooth extraction auxiliary tool 1 of the present embodiment, as in the first embodiment, the operator may pull out the tooth X2 from the gum X1 while gripping the second auxiliary substrate 12 with the fingertips without using the tooth extraction tool 2 having a shape similar to the spoon shape. The tooth extraction tool 2 may be used in combination with the auxiliary tool 1 of the first embodiment (refer to FIG. 1).

### Third Embodiment

(Configuration)

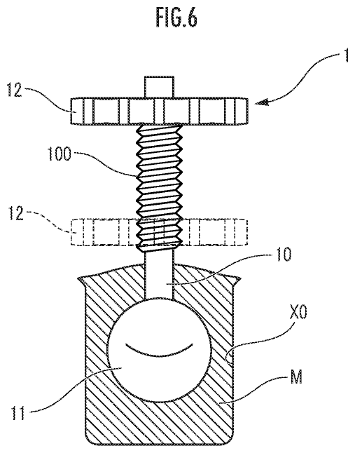

The tooth extraction auxiliary tool 1 as a third embodiment of the present invention illustrated in FIG. 6 includes the first auxiliary substrate 11, the second auxiliary substrate 12, and the connection portion 10 that connects the first auxiliary substrate 11 and the second auxiliary substrate 12.

The first auxiliary substrate 11 is formed in a substantially spherical shape having a size which can be inserted into the recessed portion X0 drilled in the crown of the tooth X2 in a state where the tooth root is embedded in the gum X1.

The second auxiliary substrate 12 is formed in a substantially annular plate shape having the diameter larger than the diameter of the first auxiliary substrate 11. A female screw portion is formed on an inner surface of the second auxiliary substrate 12. As in the first embodiment, the inner surface of the second auxiliary substrate 12 may have a protruding stripe portion, a recessed stripe portion, and/or a protruding portion for preventing slippage.

The connection portion 10 is formed in a substantially cylindrical shape or a rod shape having a smaller diameter than that of the first auxiliary substrate 11. A side surface of the connection portion 10 has a male screw portion 100 screwed into a female screw portion of the second auxiliary substrate 12. The connection portion 10 is integrally or detachably fixed to the first auxiliary substrate 11 in one end portion for the first auxiliary substrate 11 so that a central axis of the connection portion 10 coincides with or substantially coincides with a central axis of the first auxiliary substrate 11. The connection portion 10 is screwed to the second auxiliary substrate 12 so that the central axis of the connection portion 10 coincides with or substantially coincides with the central axis of the second auxiliary substrate 12.

(Using Method)

A using method of the tooth extraction auxiliary tool 1 having the above-described configuration will be described. First, as illustrated in FIG. 6, the recessed portion X0 having such a size that the first auxiliary substrate 11 can be inserted is formed by a cutting tool in the crown of the tooth X2, and the first auxiliary substrate 11 is inserted into the recessed portion X0 (refer to FIG. 2/STEP 1). Subsequently, the second auxiliary substrate 12 is turned to widen an interval between the first auxiliary substrate 11 and the second auxiliary substrate 12. The reason is to prevent the second auxiliary substrate 12 from interfering with the work when the hot melt adhesive is injected into the recessed portion X0 of the tooth X2.

Next, as illustrated in FIG. 6, the hot melt adhesive M melted by using a hot melt injection tool is injected into the recessed portion X0 in a state where the first auxiliary substrate 11 is inserted, and the hot melt adhesive M is solidified (refer to FIG. 2/STEP 2). In this manner, the tooth extraction auxiliary tool 1 is fixed to the tooth X2 with the solidified hot melt adhesive M.

Subsequently, the second auxiliary substrate 12 is turned in the direction opposite to the previous direction, and the interval between the first auxiliary substrate 11 and the second auxiliary substrate 12 is narrowed. Then, while the operator holding the first substrate 21 of the tooth extraction tool 2 having the configuration as illustrated in FIG. 4 searches for the upper surface portion of the dentition adjacent to the tooth X2 (in the direction in which the second substrate 22 is inserted into the oral cavity) with the bottom portion 220, the engagement hole 222 of the second substrate 22 is hooked on the second auxiliary substrate 12 of the tooth extraction auxiliary tool 1. Thereafter, the tooth extraction tool 2 is moved in a direction away from the gum X1 so that the tooth X2 is pulled out from the gum X1 together with the tooth extraction auxiliary tool 1 (refer to FIG. 2/STEP 3).

In the present embodiment, an interval adjustment mechanism for adjusting the interval between the first auxiliary substrate 11 and the second auxiliary substrate 12 is configured to include the male screw portion 100 formed on the side surface of the substantially cylindrical connection portion 10 and the female screw portion formed on the inner surface of the substantially annular second auxiliary substrate 12 and screwed to the male screw portion 100. In addition, for example, the interval adjustment mechanism may be configured to include a structure in which the length of the connection portion 10 can be changed and fixed in a slidable manner.

According to the tooth extraction auxiliary tool 1 of the present invention, and the tooth extraction tool set configured to include the tooth extraction auxiliary tool 1 and the tooth extraction tool 2, even patients such as children and/or elderly persons feel relieved, safe, and less burdensome when the tooth is extracted. The tooth extraction auxiliary tool 1 and the tooth extraction tool set according to the present invention are also applicable to tooth extraction of pets or domestic animals.

### DESCRIPTION OF REFERENCE NUMERALS

1: tooth extraction auxiliary tool
2: tooth extraction tool
10: connection portion
11: first auxiliary substrate
12: second auxiliary substrate
120: protruding stripe portion
100: male screw portion (interval adjustment mechanism)
X0: recessed portion
X1: gum
X2: tooth
M: hot melt adhesive

1. A tooth extraction auxiliary tool comprising:
a first auxiliary substrate inserted into a recessed portion formed in a tooth;
a second auxiliary substrate;
a connection portion that connects the first auxiliary substrate and the second auxiliary substrate; and
an interval adjustment mechanism for adjusting an interval between the first auxiliary substrate and the second auxiliary substrate via the connection portion.

2. The tooth extraction auxiliary tool according to claim 1,
wherein the interval adjustment mechanism is configured to include a male screw portion formed in the connection portion and a female screw portion formed in the second auxiliary substrate and screwed to the male screw portion.

3. A tooth extraction tool set comprising:
the tooth extraction auxiliary tool according to claim 1; and
a tooth extraction tool having an engagement portion guided to a gap between the second auxiliary substrate and the tooth and engaging with the second auxiliary substrate, in a state where the first auxiliary substrate is inserted into the recessed portion formed in the tooth.

4. The tooth extraction tool set according to claim 3,
wherein the tooth extraction tool includes a first substrate extending in a longitudinal direction and a second substrate connected to one end portion of the first substrate in the longitudinal direction and inserted into an oral cavity of a patient, and
at least one of an engagement cutout portion that divides a tip portion of the second substrate, and an engagement hole in the second substrate, the engagement hole being configured to include a first hole through which the second auxiliary substrate is allowed to pass in the second substrate and a second hole through which the second auxiliary substrate is not allowed to pass and continuous with the first hole, is formed in the second substrate, as the engagement portion.

5. The tooth extraction tool set according to claim 4,
wherein the second substrate of the tooth extraction tool is formed in a convex curved surface shape, and a bottom portion of the second substrate is formed in a flat shape, or is formed in a convex curved surface shape having a smaller curvature than a periphery of the bottom portion.
